(19) United States
(12) Patent Application Publication
(10) Pub. No.: US 2002/0170986 A1
(43) Pub. Date: Nov. 21, 2002

(54) Fuel injection valve and method for operating the same

(76) Inventors: Franz Rieger, Schwieberdingen (DE); Harald Maisch, Koengen (DE); Michael Huebel, Gerlingen (DE); Ulrich Becker, Niefern-Oeschelbronn (DE); Juergen Stein, Illingen (DE)

Correspondence Address: KENYON & KENYON, ONE BROADWAY, NEW YORK, NY, 10004, US

(21) Appl. No.: 09/958,372

(22) PCT Filed: Feb. 2, 2001
(86) PCT No.: PCT/DE01/00423

(30) Foreign Application Priority Data
Feb. 4, 2000 (DE) 100 04 961.3

(51) Int. Cl. F02M 51/00

(52) U.S. Cl. 239/585.1

(57) ABSTRACT

A fuel injector (1), in particular a fuel injector (1) for fuel injection systems, includes a first solenoid (2) cooperating with an armature (3), a second solenoid (4) cooperating with the armature (3), and a valve needle (13) friction-locked to the armature (3) for actuating a valve closing body, a force being exertable on the armature (3) in a closing direction using the first solenoid (2) and in an opening direction using the second solenoid (4).

### BACKGROUND INFORMATION

The present invention is based on a fuel injector according to the preamble of claim 1 and a method of operating a fuel injector according to the preamble of claim 10.

The closing times of fuel injectors are lengthened by adhesion forces between armature and core, as well as by eddy currents. It is known that delays can be reduced by making a current flow through the solenoid in the reverse direction at the end of the current pulse which excites the fuel injector in order to accelerate the decay of the residual field. The design of the corresponding control element is, however, complex and also only results in a slight shortening of the closing time.

Another option is to build up one magnetic field to open the fuel injector and a second magnetic field to hold the fuel injector in its open position. The intensity of the holding field can then be selected to be sufficiently low for the eddy currents to be small after the holding field is shut off, and thus the closing time can be shortened.

German Patent 23 06 007 C3 describes an electromagnetically actuated fuel injector for injecting fuel into an internal combustion engine in which the solenoid has three windings, which are supplied by three separate circuits. The first circuit is used for rapidly opening the fuel injector, the second circuit is used for holding the fuel injector open, and the third circuit is used for generating a counter-field extinguishing the residual magnetic field in order to rapidly close the fuel injector.

The disadvantage of the fuel injector known from German Patent 23 06 007 C3 is in particular the complex manufacturing process of an arrangement having three circuits, which supply three windings of the solenoid. The increased space required by the circuits is another disadvantage. No active resetting through a magnetic force component acting in the closing direction takes place.

### ADVANTAGES OF THE INVENTION

The fuel injector according to the present invention having the features of claim 1 has the advantage over the related art that a closing force can be generated in the closing direction using the first solenoid. According to the method described in claim 10, the opening operation can be prepared by energizing both solenoids and subsequently switching off the solenoid acting in the closing direction. The beginning of the injection operation is then advantageously triggered by switching off one of the two solenoids, which is the opposite of the mode of operation of the conventional arrangement, where the opening operation is triggered by energizing the solenoid. The switching dynamics are positively influenced by the magnetic fields already present, which results in short opening times. The reverse procedure can be used in the closing operation in order to achieve short closing times.

Advantageous refinements of and improvements on the fuel injector described in claim 1 and the method described in claim 10 are possible through the measures presented in the subclaims.

The influence of eddy currents can be reduced by providing the magnetic circuit, e.g., the core parts or the injector housing, with an axial slit.

A radial gap between the magnetic circuits, which is filled with a non-magnetizable material, results in maximizing the magnetic forces, since the magnetic flux is weakened as it passes through the insulating material. Thus the magnetic fields do not interfere with one another.

The maximum force and a force equilibrium can be adjusted via the length in the radial direction of the gap arranged between the solenoids. The position of the gap in the axial direction with respect to the two solenoids allows the arrangement to be made symmetrical.

Also advantageous is energizing the two solenoids with currents of opposite polarities and approximately the same intensity, which induce two opposite fields.

Also advantageous are recesses in the armature parts, which allow the weight of the movable parts to be substantially reduced without affecting the magnetic force.

### DRAWING

An embodiment of the present invention is illustrated in the drawing in a simplified manner and explained in more detail in the description that follows.

FIG. 1 shows a partial section through an embodiment of a fuel injector according to the present invention;

FIG. 2 shows a diagram of the switching phases of the embodiment illustrated in FIG. 1 of the fuel injector according to the present invention and the forces acting during the switching operations;

FIG. 3 shows a detail of the fuel injector according to the present invention illustrated in FIG. 1 in area III of FIG. 1;

FIGS. 4A-4B show the diffusion of the magnetic field for a magnetic core without a slit and with two slits in section plane IV-IV of FIG. 1; and

FIGS. 5A-5B show the eddy currents in a magnetic core without a slit and with two slits in section plane V-V of FIG. 1.

### DESCRIPTION OF THE EXEMPLARY EMBODIMENT

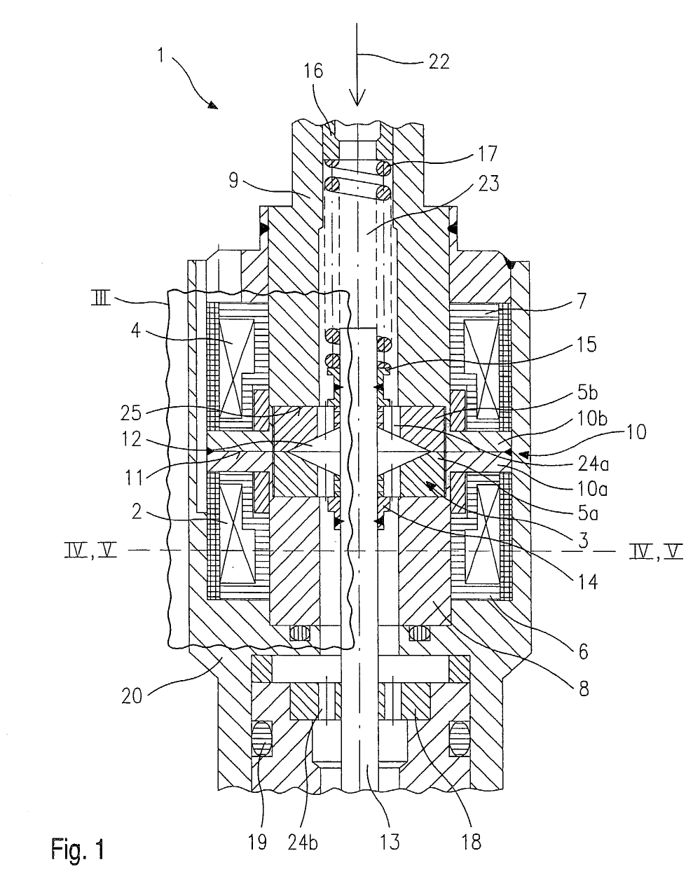

FIG. 1 shows a partial section through the central part of a fuel injector 1. Fuel injector 1 is designed in particular for direct injection of fuel into a combustion chamber (not illustrated) of an internal combustion engine in which a compressed mixture is externally ignited. Fuel injector 1 can be designed as an inward-opening or an outward-opening fuel injector 1. The embodiment illustrated in FIG. 1 is an inward-opening fuel injector 1.

Fuel injector 1 includes a first solenoid 2, which cooperates with a first armature part 5a of an armature 3, which is a two-part armature in this embodiment, and a second solenoid 4, which cooperates with a second armature part 5b of armature 3. First solenoid 2 is wound onto a first field spool 6 and second solenoid 4 is wound onto second field spool 7. First solenoid 2 surrounds a first core part 8, while second solenoid 4 surrounds a second core part 9. First solenoid 2 and second solenoid 4 are separated in the axial direction by a web 10. Web 10 is composed of a first web part 10a facing first solenoid 2 and a second web part 10b facing second solenoid 4; the two web parts are separated by a layer 11 made of non-magnetizable material.

Web parts 10a and 10b are not necessarily of the same size. The axial position of layer 11 can be adjusted in order to optimize the opening or closing operation. If the equilibrium of forces is optimized to favor the opening operation, for example, the axial position of non-magnetizable layer 11 is slightly shifted from the center position toward first solenoid 2. Thus the magnetic flux density in web part 10a adjacent to first solenoid 2 is increased with respect to that in web part 10b.

First armature part 5a and second armature part 5b are arranged between first core part 8 and second core part 9. In this embodiment, each armature part 5a and 5b has a conical recess 12 which results in a reduction in weight of the movable parts.

A valve needle 13 extends through first core part 8, second core part 9, and the two armature parts 5a and 5b. When fuel injector 1 is closed, a working gap 25 is formed between second armature part 5b and second core part 9. First armature part 5a is mechanically linked to valve needle 13 via a first flange 14, while second armature part 5b is mechanically linked to valve needle 13 via a second flange 15.

A restoring spring 17, which presses valve needle 13 in the direction of injection onto a sealing seat (not illustrated) and thus holds fuel injector 1 in the closed position, is mounted between a pre-tensioning sleeve 16 pressed, in particular, into a central recess 23 of second core part 9 and second flange 15.

Viewed from first core part 8 in the direction of injection, a guide element 18, a sealing element 19, and a valve closing body (not illustrated) follow.

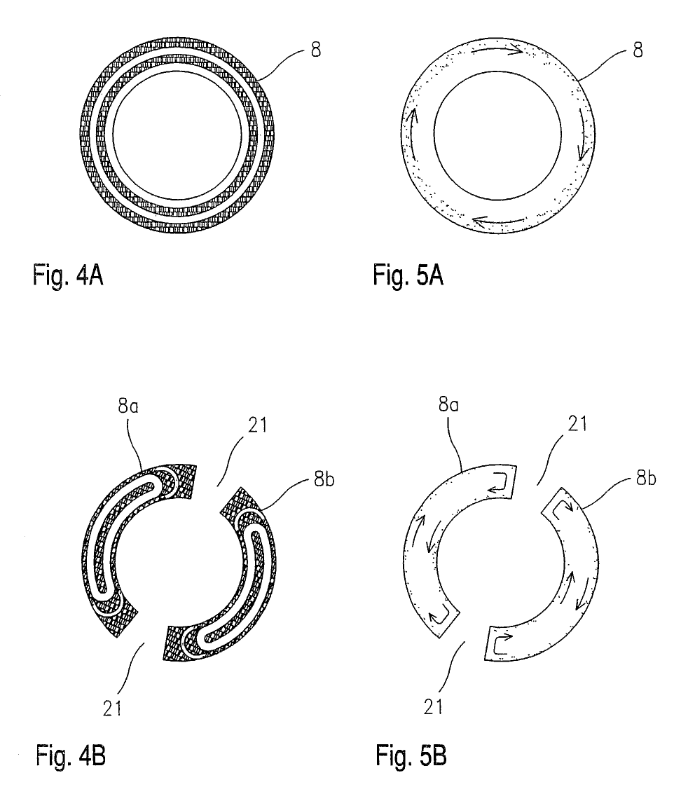

Fuel injector 1 is surrounded by an injector housing 20, which has one slit or, ideally, two slits 21 in the area of second solenoid 4 and in the area of first solenoid 2, for example. These slits run in the axial direction and are responsible for reducing the influence of eddy currents, i.e., of the diffusion of the magnetic field induced in injector housing 20 during the operation of fuel injector 1. As an alternative to a slitted injector housing 20, such slits 21 can also be provided in core parts 8 and 9, for example, as can be seen in FIGS. 4B and 5B.

The fuel is supplied in the center and is guided to the sealing seat in the flow direction shown by arrow 22 through central recess 23 of fuel injector 1 and through fuel channels 24a in armature parts 5a and 5b and fuel channels 24b in guide element 18.

If excitation currents in opposite directions are applied to first solenoid 2 and second solenoid 4, magnetic fields of opposite polarities are induced in first solenoid 2 and second solenoid 4. Since the magnetic fields in first solenoid 2 and in second solenoid 4 have opposite polarities, the effect of the magnetic fields in the direction of injection and in the direction of feed is initially canceled out. Armature 3 is held in contact with first core part 8 by the magnetic force of first solenoid 2 acting on it. The effect of second solenoid 4 is small due to working gap 25 between second armature part 5b and second core part 9.

In order to open fuel injector 1, the current which excites first solenoid 2 is switched off, whereby no more magnetic force is exerted by first solenoid 2 on armature 3. Armature 3 is now drawn into second solenoid 4 by a distance which corresponds to working gap 25 against the force of restoring spring 17. Thus valve needle 13 is entrained by armature 3 in the opening direction via second flange 15. At the injection side end of valve needle 13, a valve closing body (not illustrated) is formed, which is lifted by the motion of valve needle 13 from a valve seat surface (not illustrated), thus opening fuel injector 1.

Working gap 5b formed between second armature part 5b and second core part 9 is now closed. A working gap 25 of the same size is between first armature part 5a and first core part 8 when fuel injector 1 is open.

In preparation for the closing operation, first solenoid 2 is energized again, so that a force acts on armature 3 in the direction of first solenoid 2 which, however, is less than the force exerted by second solenoid 4 due to working gap 25. If now the current which excites second solenoid 4, is switched off, armature 3, together with valve needle 13, is accelerated in the direction of injection by the sum of forces of restoring spring 17 and first solenoid 2. A rapid closing motion is achieved due to first solenoid 2 having been energized previously and the resulting drop of armature 3 from second core part 9. Short and, more importantly, accurate closing times, which are only slightly influenced by adhesion and eddy currents, are the positive result.

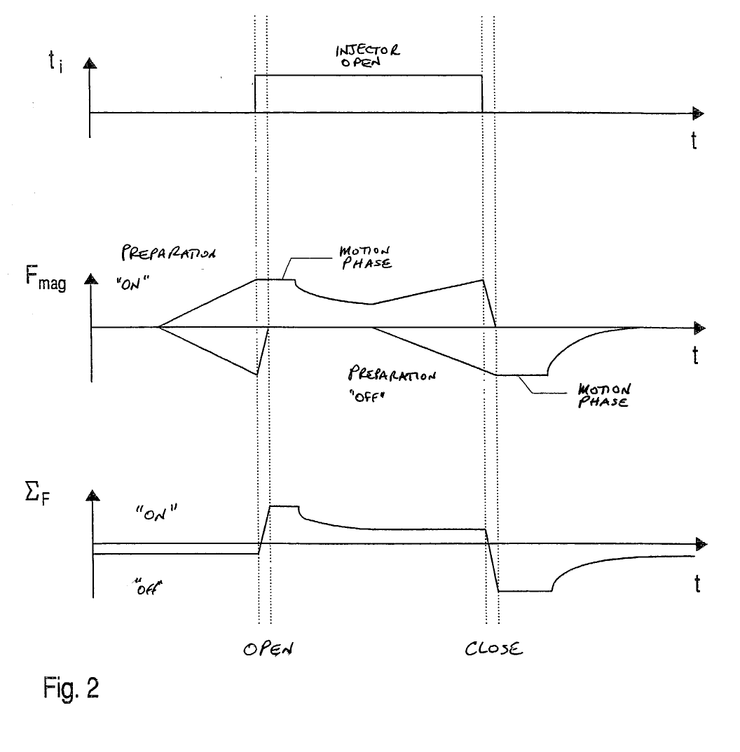

FIG. 2 qualitatively shows the forces acting during the opening and closing operations of fuel injector 1.

The top diagram indicates electrical control command t₁ for opening the injector. In the second diagram in the center, the acting magnetic forces F_{mag} are shown as a function of time t. The magnetic force of second solenoid 4 is shown above the time axis, while the magnetic force of first solenoid 2 is shown under the time axis. In preparation for opening fuel injector 1, first solenoid 2 and second solenoid 4 are energized at the same time with currents of the same absolute value but of opposite polarities. When the two magnetic fields have reached their full intensity, first solenoid 2 is switched off in order to open fuel injector 1. The magnetic force of second solenoid 4 attracts armature 3 in the opening direction. When armature 3 hits second core part 9, the magnetic force can be reduced by reducing the excitation current to the necessary holding force.

In preparation for closing fuel injector 1, first solenoid 2 is energized again and, at the same time, the excitation current through second solenoid 4 is increased again. Thus first solenoid 2 exerts a magnetic force on armature 3 again, which, together with the force of restoring spring 17, moves valve needle 13, via first flange 14 and second flange 15, in the closing direction after second solenoid 4 is switched off. After completion of the motion phase of armature 3, the magnetic force slowly drops to zero after the current which excites first solenoid 2 is switched off.

The bottom diagram of FIG. 2 represents the sum of forces (magnetic force of first and second solenoids 2 and 4 and restoring force of restoring spring 17). If first solenoid 2 and second solenoid 4 are energized in the preparation phase for opening fuel injector 1, only the restoring force of restoring spring 17 remains as the resultant force, since the magnetic fields are of the same intensity but opposite polarities. Restoring spring 17 holds fuel injector 1 closed in this phase. If first solenoid 2 is switched off, the magnetic force of second solenoid 4 will exceed the restoring force of restoring spring 17, opening fuel injector 1. When armature 3 reaches its end position, the magnetic force is reduced again by the reduction of the excitation current to its holding current intensity. However, it still exceeds the force of restoring spring 17, so that fuel injector 1 remains in the open position. When first solenoid 2 is energized again in preparation for the closing operation, initially this has no effect on the prevailing relationship of forces. The magnetic force of first solenoid 2 and the restoring force of restoring spring 17 do not act in the same direction until second solenoid 4 is turned off, whereby fuel injector 1 is closed.

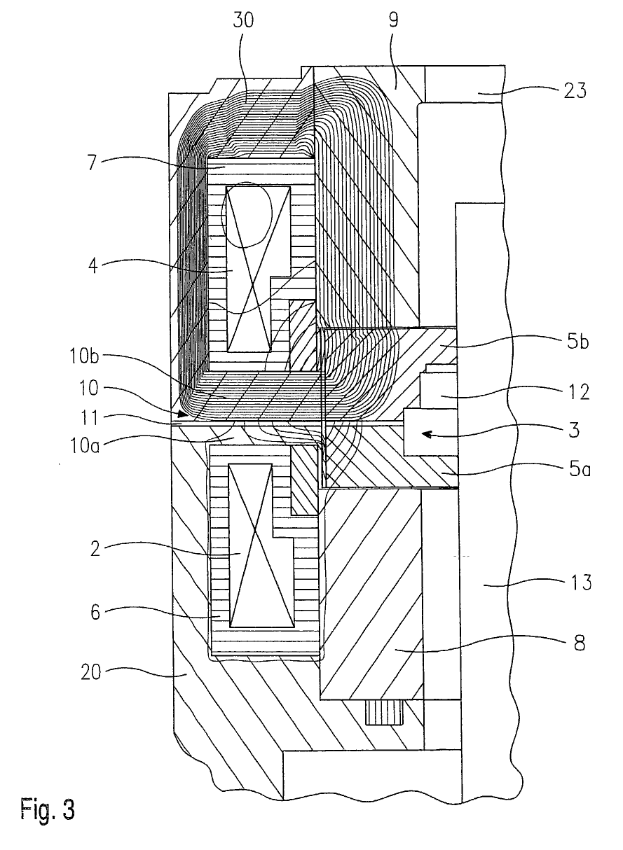

FIG. 3 shows a partial section through a detail of the embodiment of fuel injector 1 according to the present invention described in FIG. 1 in area III of FIG. 1. In order to illustrate the effect of non-magnetizable layer 11 between first web part 10a and second web part 10b between first solenoid 2 and second solenoid 4, the energized and non-energized states of first solenoid 2 and second solenoid 4 during the open phase of fuel injector 1 are shown. The drawing only shows those parts of fuel injector 1 which are needed to elucidate the operation. Components described previously are identified with the same reference symbols.

It can be seen from magnetic field lines 30 shown in FIG. 3 that they only penetrate injector housing 20 in the area of second solenoid 4, second core part 9, and second armature part 5b due to the geometry of the arrangement and the position of non-magnetizable layer 11. Those portions of the magnetic field which penetrate first armature part 5a, injector housing 20 in the area of first solenoid 2, and first core part 8 are extremely small. The material of non-magnetizable layer 11 and its position between first solenoid 2 and second solenoid 4, and its axial extent can be selected so that the losses almost entirely disappear. The position of layer 11 makes it possible to optimize either the opening or the closing operation, depending on whether layer 11 is arranged closer to first solenoid 2 or second solenoid 4, since either first armature part 5a or second armature part 5b are influenced more strongly by the respective magnetic field. In order to simplify the manufacturing of injector housing 20, when it is desirable, for example, to make injector housing 20 of a single piece, the radial extent of layer 11 does not need to divide the entire injector housing 20. It is sufficient to provide a slit up to the desired radial extent in injector housing 20 and to fill it with non-magnetizable layer 11.

In order to illustrate the previously mentioned radial slits 21, the diffusion of the magnetic field is shown in FIGS. 4A and 4B in a radial sectional view and the shape of the eddy currents in core part 8 is shown in FIGS. 5A and 5B in a radial sectional view. The slits run along lines IV-IV, V-V in FIG. 1.

FIG. 4A shows a radial section through an unslitted core part 8 along IV-IV and the diffusion of the magnetic field of first solenoid 2 induced in core part 8 for comparison.

FIG. 4B shows a radial section through core part 8 along line IV-IV in a doubly slitted area and the diffusion of the magnetic field of first solenoid 2 induced in core part 8. Core part 8 is subdivided into two parts 8a and 8b by slit 21. The magnetic field is not a closed circle between parts 8a and 8b due to slits 21. Thus losses can be kept low, which has a positive effect on the excitation performance of the magnetic circuits.

FIG. 5A shows the shape of the eddy currents in a closed core part 8 in a radial section along line V-V for comparison. The eddy currents are highly pronounced due to the uninterrupted shape of core part 8 and therefore have a substantial effect on the closing time of fuel injector 1.

FIG. 5B shows a section along line V-V through doubly slitted core part 8. The eddy currents do not occur here due to slit 21, but build up in the two parts 8a and 8b to form closed eddy currents again. The effect of the eddy currents is thereby reduced overall.

The present invention is not limited to the described embodiment, but is suited for fuel injectors 1 of any design, in particular also for outward-opening fuel injectors 1.

What is claimed is:

1. A fuel injector (1), in particular a fuel injector (1) for fuel injection systems of internal combustion engines, having a first solenoid (2) cooperating with an armature (3), a second solenoid (4) cooperating with the armature (3), and a valve needle (13), friction-locked to the armature (3), for actuating a valve closing body, wherein a force can be exerted on the armature (3) in a closing direction using the first solenoid (2) and in an opening direction using the second solenoid (4).

2. The fuel injector according to claim 1,
wherein an injector housing (20) or core parts (8, 9) used as an internal pole of the fuel injector (1) have at least one slit (21) in the axial direction.

3. The fuel injector according to claim 2,
wherein the slit (21) extends along at least one of the solenoids (2, 4).

4. The fuel injector according to one of claims 1 to 3,
wherein there is a non-magnetizable layer (11) between the first solenoid (2) and the second solenoid (4).

5. The fuel injector according to claim 4,
wherein the non-magnetizable layer (11) divides a web (10) arranged between the first solenoid (2) and the second solenoid (4) into a first web part (10a) facing the first solenoid (2) and a second web part (10b) facing the second solenoid (4).

6. The fuel injector according to claim 5,
wherein the distance between the first solenoid (2) and the non-magnetizable layer (11) and the distance between the second solenoid (4) and the non-magnetizable layer (11) are of different magnitudes.

7. The fuel injector according to claim 6,
wherein the non-magnetizable layer (11) is closer to the first solenoid (2) than to the second solenoid (4).

8. The fuel injector according to one of claims 1 through 7,
wherein the armature (3) is made of two parts and is divided into a first armature part (5a) and a second armature part (5b), the first armature part (5a) being mechanically linked to the valve needle (13) via a first flange (14), and the second armature part (5b) being mechanically linked to the valve needle (13) via a second flange (15).

9. The fuel injector according to one of claims 1 through 8,
wherein the first armature part (5a) and the second armature part (5b) each have a conical recess (12).

10. A method of operating a fuel injector (1), in particular a fuel injector (1) for fuel injection systems, having a first solenoid (2) cooperating with an armature (3), a second solenoid (4) cooperating with the armature (3), and a valve needle (13), friction-locked to the armature (3), for actuating a valve closing body, a force being exertable on the armature (3) in a closing direction using the first solenoid (2) and in an opening direction using the second solenoid (4),
wherein, in order to open the fuel injector (1), initially both the first solenoid (2) and the second solenoid (4) are energized and subsequently the first solenoid (2) is switched off.

11. The method according to claim 10,
wherein, in order to close the fuel injector (1), the first solenoid (2) is energized again and the second solenoid (4) is subsequently switched off.
